(19) United States
(12) Patent Application Publication
(10) Pub. No.: US 2026/0157524 A1
(43) Pub. Date: Jun. 11, 2026

(54) LUMBAR SUPPORT ADJUSTING DEVICE FOR CHAIR

(71) Applicant: CHUENG SHINE CO., LTD., Taibao City (TW)

(72) Inventor: Wu-Chin Lu, Taibao City (TW)

(21) Appl. No.: 18/972,610

(22) Filed: Dec. 6, 2024

(51) Int. Cl. A47C 7/46

(52) U.S. Cl. CPC A47C 7/462

(57) ABSTRACT

A lumbar support adjusting device includes an adjuster mounted between a backrest and a lumbar support of a chair to adjust an angle of the lumbar support. The adjuster includes a fixed base, a left shell, a right shell, an adjusting toothed wheel, an axle bolt, and an adjusting knob. The fixed base is mounted between the left shell and the right shell. The adjusting toothed wheel is mounted between the left shell and the fixed base. The left shell and the right shell are locked by a combination screw. The left shell, the fixed base, and the right shell are assembled by the axle bolt. The adjusting knob is mounted on the left shell to adjust a relative angle and position between the fixed base and the left shell together with the right shell.

### BACKGROUND OF THE INVENTION

### Field of the Invention

The present invention relates to an adjusting device and, more particularly, to a lumbar (or waist) support adjusting device for a chair.

### Description of the Related Art

A conventional office chair comprises a seat, a backrest mounted on the seat, and a lumbar support (or cushion) mounted on the backrest. The height of the lumbar support may be adjusted according to the user's stature to provide a comfortable sensation to the user. However, the angle and position of the lumbar support cannot be adjusted freely according to the user's requirement so that the lumbar support is not designed ergonomically and cannot keep the user at the most comfortable state.

### BRIEF SUMMARY OF THE INVENTION

The primary objective of the present invention is to provide a lumbar support adjusting device that adjusts the angle of a lumbar support of a chair.

In accordance with the present invention, there is provided a lumbar support adjusting device for a chair, comprising an adjuster mounted between a backrest and a lumbar support of a chair to adjust an angle of the lumbar support. The adjuster includes a fixed base, a left shell, a right shell, an adjusting toothed wheel, an axle bolt, and an adjusting knob. The fixed base has a left side having an interior provided with two stop portions. A compression spring is mounted in the left side of the fixed base. The fixed base has a right side having an interior provided with two arcuate grooves. The fixed base has a rear side provided with a fitting hole. The left shell has an upper end provided with a left bushing. The left bushing has a right side having an interior provided with an annular toothed rack. The adjusting toothed wheel is mounted in the right side of the left bushing. The adjusting toothed wheel has a left side provided with two pillars and multiple positioning teeth. The positioning teeth mesh with the annular toothed rack of the left bushing. The adjusting toothed wheel has a right side provided with two limit plates. The left bushing is provided with two arcuate holes, and the two pillars of the adjusting toothed wheel extend through the two arcuate holes of the left bushing and protrude from a left side of the left bushing. The left shell has a middle having a right side provided with a mortise. The left shell has a lower end having a right side provided with a tongue groove. A pivot hole is formed in the tongue groove and extends to a left side of the left shell. The right shell has an upper end provided with a right bushing. The right bushing has a left side provided with two arcuate plates. A torsion spring is mounted in the left side of the right bushing. The right shell has a middle having a left side provided with a fitting tenon. The right shell has a lower end having a left side provided with a tongue. A pivot hole is formed in the tongue and extends to the right side of the right shell. The left shell is mounted on the left side of the fixed base. The right shell is mounted on the right side of the fixed base. The fitting tenon of the right shell is inserted into the mortise of the left shell. The tongue of the right shell is inserted into the tongue groove of the left shell. The left shell and the right shell are locked by a combination screw. The left shell, the fixed base, and the right shell are assembled together by the axle bolt. The adjusting knob is mounted on the left side of the left bushing of the left shell. The adjusting knob is locked on the two pillars of the adjusting toothed wheel by two screws. The adjusting knob is pressed and rotated so that the positioning teeth of the adjusting toothed wheel are detached from the annular toothed rack of the left bushing and are moved, to adjust a relative angle and position between the fixed base and the left shell together with the right shell.

According to the primary advantages of the present invention, when the adjuster is mounted on the chair, the adjuster is operated to change and adjust the fixed position or swinging amplitude of the lumbar support, to satisfy the user's practical requirement.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a schematic view showing a practical state of a lumbar support adjusting device for a chair in accordance with the preferred embodiment of the present invention.

FIG. 2 is an exploded perspective view of an adjuster of the lumbar support adjusting device for a chair in accordance with the preferred embodiment of the present invention.

FIG. 3 is another exploded perspective view of the adjuster of the lumbar support adjusting device for a chair in accordance with the preferred embodiment of the present invention.

FIG. 4 is a perspective view of a fixed base of the adjuster in accordance with the preferred embodiment of the present invention.

FIG. 5 is a perspective view of the adjuster of the lumbar support adjusting device for a chair in accordance with the preferred embodiment of the present invention.

FIG. 6 is a locally enlarged view of the lumbar support adjusting device for a chair as shown in FIG. 1.

FIG. 7 is a schematic operational view of the lumbar support adjusting device for a chair as shown in FIG. 6.

FIG. 8 is a schematic operational view of the lumbar support adjusting device for a chair as shown in FIG. 7.

### DETAILED DESCRIPTION OF THE INVENTION

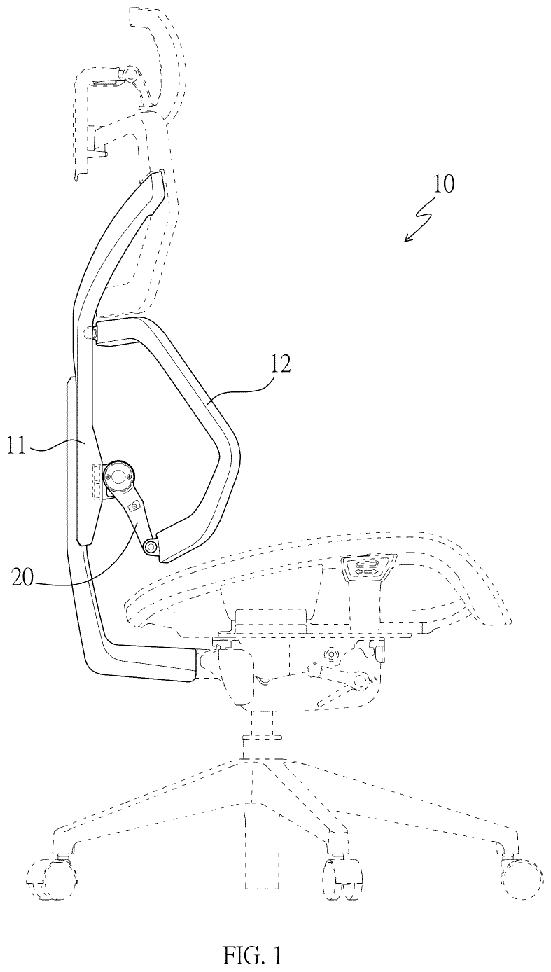

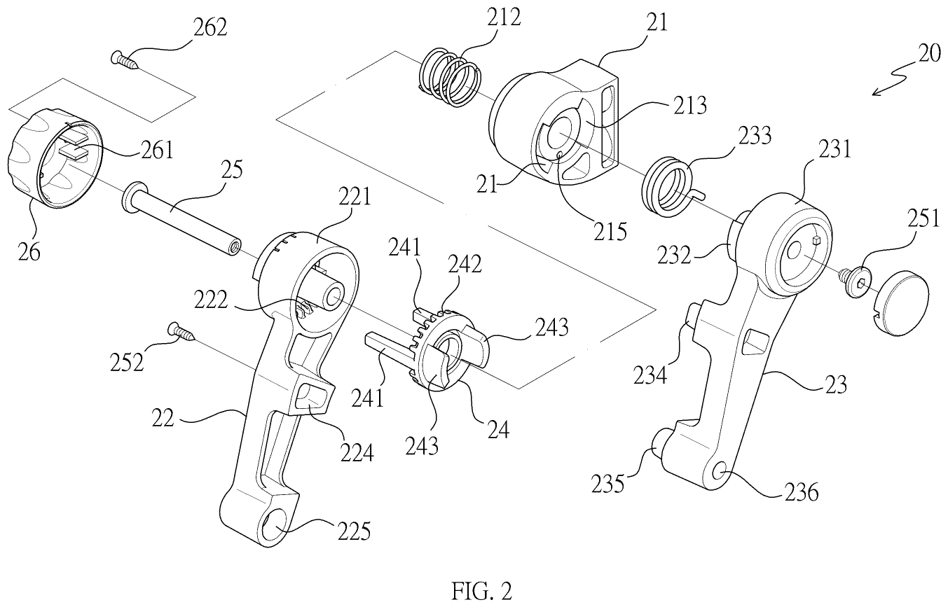

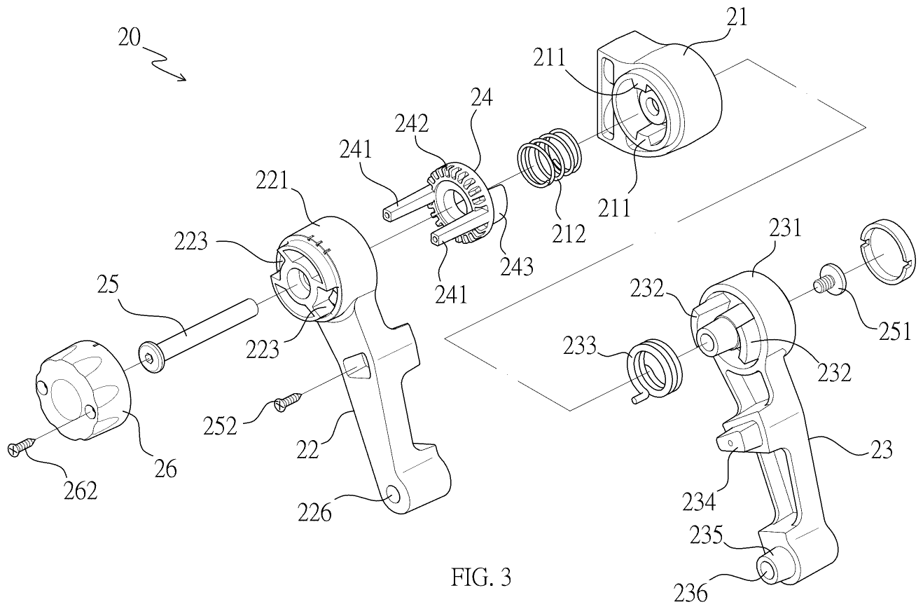

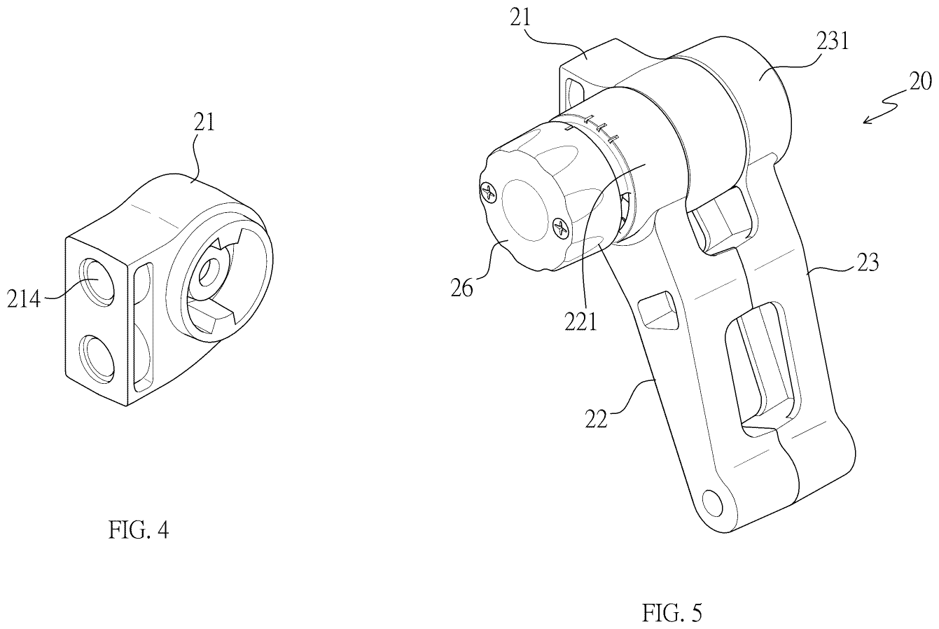

Referring to the drawings and initially to FIGS. 1-5, a lumbar support adjusting device for a chair in accordance with the preferred embodiment of the present invention comprises an adjuster 20 mounted between a backrest 11 and a lumbar support 12 of a chair 10 to adjust an angle of the lumbar support 12. The adjuster 20 includes a fixed base 21, a left shell 22, a right shell 23, an adjusting toothed wheel (or disk) 24, an axle bolt 25, and an adjusting knob 26.

The fixed base 21 has a left side having an interior provided with two stop portions 211. A compression spring 212 is mounted in the left side of the fixed base 21. The fixed base 21 has a right side having an interior provided with two arcuate grooves 213. The fixed base 21 has a rear side provided with a fitting hole 214.

The left shell 22 has an upper end provided with a left bushing 221. The left bushing 221 has a right side having an interior provided with an annular toothed rack 222. The adjusting toothed wheel 24 is mounted in the right side of the left bushing 221. The adjusting toothed wheel 24 has a left side provided with two pillars 241 and multiple positioning teeth 242. The positioning teeth 242 mesh with the annular toothed rack 222 of the left bushing 221. The adjusting toothed wheel 24 has a right side provided with two limit plates 243. The left bushing 221 is provided with two arcuate holes 223, and the two pillars 241 of the adjusting toothed wheel 24 extend through the two arcuate holes 223 of the left bushing 221 and protrude from a left side of the left bushing 221. The left shell 22 has a middle having a right side provided with a mortise 224. The left shell 22 has a lower end having a right side provided with a tongue groove 225. A pivot hole 226 is formed in the tongue groove 225 and extends to a left side of the left shell 22.

The right shell 23 has an upper end provided with a right bushing 231. The right bushing 231 has a left side provided with two arcuate plates 232. A torsion spring 233 is mounted in the left side of the right bushing 231. The right shell 23 has a middle having a left side provided with a fitting tenon 234. The right shell 23 has a lower end having a left side provided with a tongue 235. A pivot hole 236 is formed in the tongue 235 and extends to the right side of the right shell 23.

The left shell 22 is mounted on the left side of the fixed base 21. The two limit plates 243 of the adjusting toothed wheel 24 extend through a space defined between the two stop portions 211 of the fixed base 21. The compression spring 212 pushes the adjusting toothed wheel 24. The right shell 23 is mounted on the right side of the fixed base 21. The two arcuate plates 232 of the right bushing 231 extend into the two arcuate grooves 213 of the fixed base 21. The torsion spring 233 has a first end hooked on the two arcuate plates 232. The right side of the fixed base 21 is provided with an insert hole 215, and the torsion spring 233 has a second end inserted into the insert hole 215. The axle bolt 25 extends through the left bushing 221 of the left shell 22, the fixed base 21, and the right bushing 231 of the right shell 23, and is screwed with a bolt screw 251, so that the left shell 22, the fixed base 21, and the right shell 23 are assembled together.

When the left shell 22, the fixed base 21, and the right shell 23 are assembled, the fitting tenon 234 of the right shell 23 is inserted into the mortise 224 of the left shell 22, the tongue 235 of the right shell 23 is inserted into the tongue groove 225 of the left shell 22, and a combination screw 252 extends through the mortise 224 of the left shell 22 and is screwed into the fitting tenon 234 of the right shell 23, so that the left shell 22 and the right shell 23 are locked.

The adjusting knob 26 is mounted on the left side of the left bushing 221 of the left shell 22. The adjusting knob 26 has an interior provided with two insert grooves 261, and the two pillars 241 of the adjusting toothed wheel 24 are inserted into the two insert grooves 261 of the adjusting knob 26. Thus, the adjusting knob 26 is locked on the two pillars 241 of the adjusting toothed wheel 24 by two screws 262.

When the adjusting knob 26 is pressed, the adjusting toothed wheel 24 is pushed so that the positioning teeth 242 of the adjusting toothed wheel 24 are detached from the annular toothed rack 222 of the left bushing 221. When the adjusting knob 26 is rotated, the adjusting toothed wheel 24 is rotated and moved. After the adjusting knob 26 is released, the compression spring 212 pushes the adjusting toothed wheel 24, so that the positioning teeth 242 of the adjusting toothed wheel 24 engage the annular toothed rack 222 of the left bushing 221 again. Thus, the adjusting knob 26 is pressed and rotated to adjust a relative angle between the fixed base 21 and the left shell 22 (together with the right shell 23). At this time, the two pillars 241 of the adjusting toothed wheel 24 extend through the two arcuate holes 223 of the left bushing 221, so that the two pillars 241 of the adjusting toothed wheel 24 are moved in and limited by the two arcuate holes 223 of the left bushing 221. In addition, the two limit plates 243 of the adjusting toothed wheel 24 extend through the space defined between the two stop portions 211 of the fixed base 21, so that the two limit plates 243 of the adjusting toothed wheel 24 are limited by the two stop portions 211 of the fixed base 21. Thus, rotation of the adjusting knob 26 has a double restriction, to provide a multi-stage angle of rotation.

The torsion spring 233 is mounted between the fixed base 21 and the right bushing 231 of the right shell 23, so that a relative rotational thrust is formed between the fixed base 21 and the right shell 23 (together with the left shell 22) by a torsional elastic force of the torsion spring 233. At this time, the two arcuate plates 232 of the right bushing 231 extend into the two arcuate grooves 213 of the fixed base 21, so that rotation of the right shell 23 (together with the left shell 22) relative to the fixed base 21 is limited by the two arcuate grooves 213 of the fixed base 21. Thus, the right shell 23 (together with the left shell 22) is rotated relative to the fixed base 21 through a limited angle.

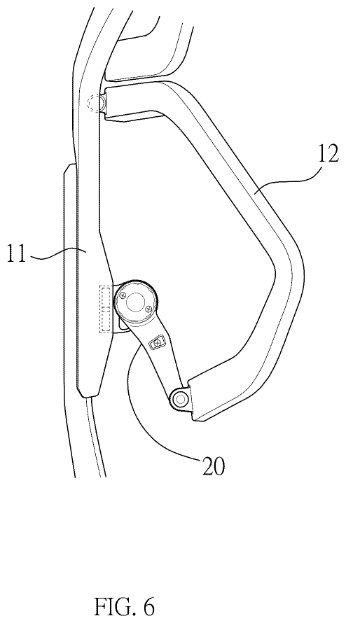

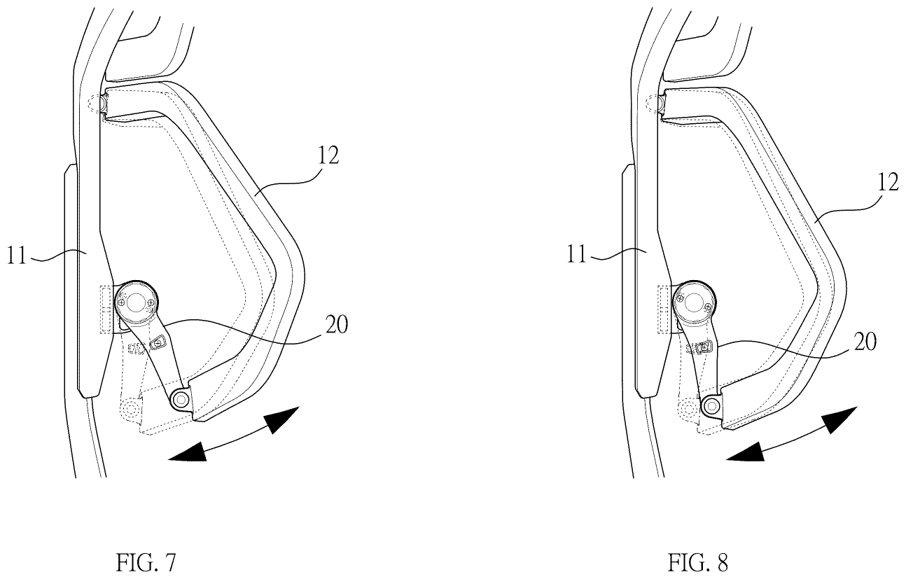

In operation, referring to FIGS. 6-8 with reference to FIGS. 1-5, the upper end of the lumbar support 12 is pivotally connected with the backrest 11, and the adjuster 20 has a first end pivotally connected with the lower end of the backrest 11 and a second end pivotally connected with the lower end of the lumbar support 12. The fixed base 21 of the adjuster 20 is screwed and affixed to the backrest 11 through the fitting hole 214 of the fixed base 21, while the left shell 22 and the right shell 23 of the adjuster 20 are pivotally connected with the lower end of the lumbar support 12 by the pivot hole 226 of the left shell 22 and the pivot hole 236 of the right shell 23. Thus, the lumbar support 12 is maintained by the adjuster 20 to support a user's waist. In adjustment, the user may press the adjusting knob 26 to detach the positioning teeth 242 of the adjusting toothed wheel 24 from the annular toothed rack 222 of the left bushing 221, and may rotate the adjusting knob 26 to change the position and angle of the lumbar support 12 according the user's requirement.

It is appreciated that, the adjusting knob 26 and the left shell 22 of the adjuster 20 are provided with marks to facilitate the user operating the adjusting knob 26.

Accordingly, when the adjuster 20 is mounted on the chair 10, the adjuster 20 is operated to adjust the fixed angle position or swinging amplitude of the lumbar support 12, to satisfy the user's practical requirement.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

What is claimed is:

1. A lumbar support adjusting device for a chair, comprising:
an adjuster mounted between a backrest and a lumbar support of a chair to adjust an angle of the lumbar support;
wherein:
the adjuster includes a fixed base, a left shell, a right shell, an adjusting toothed wheel, an axle bolt, and an adjusting knob;
the fixed base has a left side having an interior provided with two stop portions;
a compression spring is mounted in the left side of the fixed base;
the fixed base has a right side having an interior provided with two arcuate grooves;
the fixed base has a rear side provided with a fitting hole;
the left shell has an upper end provided with a left bushing;
the left bushing has a right side having an interior provided with an annular toothed rack;
the adjusting toothed wheel is mounted in the right side of the left bushing;
the adjusting toothed wheel has a left side provided with two pillars and multiple positioning teeth;
the positioning teeth mesh with the annular toothed rack of the left bushing;
the adjusting toothed wheel has a right side provided with two limit plates;
the left bushing is provided with two arcuate holes;
the two pillars of the adjusting toothed wheel extend through the two arcuate holes of the left bushing and protrude from a left side of the left bushing;
the left shell has a middle having a right side provided with a mortise;
the left shell has a lower end having a right side provided with a tongue groove;
a pivot hole is formed in the tongue groove and extends to a left side of the left shell;
the right shell has an upper end provided with a right bushing;
the right bushing has a left side provided with two arcuate plates;
a torsion spring is mounted in the left side of the right bushing;
the right shell has a middle having a left side provided with a fitting tenon;
the right shell has a lower end having a left side provided with a tongue;
a pivot hole is formed in the tongue and extends to the right side of the right shell;
the left shell is mounted on the left side of the fixed base;
the right shell is mounted on the right side of the fixed base;
the fitting tenon of the right shell is inserted into the mortise of the left shell;
the tongue of the right shell is inserted into the tongue groove of the left shell;
the left shell and the right shell are locked by a combination screw;
the left shell, the fixed base, and the right shell are assembled together by the axle bolt;
the adjusting knob is mounted on the left side of the left bushing of the left shell;
the adjusting knob is locked on the two pillars of the adjusting toothed wheel by two screws; and
the adjusting knob is pressed and rotated so that the positioning teeth of the adjusting toothed wheel are detached from the annular toothed rack of the left bushing and are moved, to adjust a relative angle and position between the fixed base and the left shell together with the right shell.
